(19) United States
(12) Patent Application Publication
(10) Pub. No.: US 2014/0199614 A1
(43) Pub. Date: Jul. 17, 2014

(54) COMPOSITE, AND ELECTRODE AND FUEL CELL INCLUDING THE COMPOSITE

(71) Applicant: Samsung Electronics Co., Ltd., Suwon-si (KR)

(72) Inventors: Dong-hee YEON, Seoul (KR); Chan KWAK, Yongin-si (KR); Doh-won JUNG, Seoul (KR); Sung-jin AHN, Anyang-si (KR); Hee-jung PARK, Suwon-si (KR)

(73) Assignee: Samsung Electronics Co., Ltd., Suwon-si (KR)

(21) Appl. No.: 14/152,073

(22) Filed: Jan. 10, 2014

(30) Foreign Application Priority Data
Jan. 14, 2013 (KR) 10-2013-0004039

(51) Int. Cl. H01M 4/86

(52) U.S. Cl. CPC H01M 4/8652
USPC 429/495; 252/182.1

(57) ABSTRACT

A composite including: a nickel compound represented by Formula 1:

Ni₁₋ₓM1ₓO_{y} Formula 1

wherein M1 is silicon (Si), germanium (Ge), molybdenum (Mo), or a combination thereof, and 0≦x≦0.3 and 0≦y≦3; and a yttria-stabilized zirconia including cerium (Ce), titanium (Ti), or a combination thereof.

### CROSS-REFERENCE TO RELATED APPLICATION

This application claims priority to and the benefit of Korean Patent Application No. 10-2013-0004039, filed on Jan. 14, 2013, and all the benefits accruing therefrom under 35 U.S.C. §119, the content of which is incorporated herein in its entirety by reference.

### BACKGROUND

1. Field

The present disclosure relates to a composite, and an electrode and a fuel cell including the composite.

2. Description of the Related Art

A solid oxide fuel cell (“SOFC”) is a highly efficient and environmentally friendly electrochemical power generation technology that directly converts chemical energy of fuel gas into electrical energy, and an SOFC uses a solid oxide as an electrolyte, the solid oxide having an ionic conductivity. An SOFC includes an anode where a fuel, such as hydrogen and hydrocarbon are oxidized, a cathode where oxygen gas is reduced to oxygen ions (O²⁻), and an ion-conducting solid oxide electrolyte where oxygen ions are conducted.

Nickel oxide/yttria-stabilized zirconia (NiO/YSZ) is widely used as an anode material of an SOFC, and the anode material desirably has excellent oxidation reaction activity for fuels such as hydrogen and hydrocarbon. Also, when an SOFC uses hydrocarbon as a fuel, an anode material that is largely resistant to carbon poisoning, which interferes with a catalytic reaction due to carbon deposition on a surface of a metal catalyst within an anode, would be desirable.

### SUMMARY

Provided is a composite having improved resistance to carbon deposition and having improved fuel oxidation reaction activity.

Provided is an electrode including the composite.

Provided is a fuel cell having improved efficiency and including the electrode.

Additional aspects will be set forth in part in the description which follows and, in part, will be apparent from the description.

According to an aspect, a composite includes: a nickel compound represented by Formula 1:

Ni₁₋ₓM1ₓO_{y} Formula 1

wherein M1 is silicon (Si), germanium (Ge), molybdenum (Mo), or a combination thereof, and 0≦x≦0.3 and 0≦y≦3; and a yttria-stabilized zirconia including cerium (Ce), titanium (Ti), or a combination thereof.

According to another aspect, an electrode includes a composite, the composite including: a nickel compound represented by Formula 1:

Ni₁₋ₓM1ₓO_{y} Formula 1

wherein M1 is silicon (Si), germanium (Ge), molybdenum (Mo), or a combination thereof, and 0≦x≦0.3 and 0≦y≦3; and a yttria-stabilized zirconia including cerium (Ce), titanium (Ti), or a combination thereof.

According to another aspect, a fuel cell includes the electrode.

Also disclosed is a solid oxide fuel cell (“SOFC”) including: a cathode; an anode including the electrode; and a solid oxide electrolyte interposed between the cathode and the anode.

### BRIEF DESCRIPTION OF THE DRAWINGS

These and/or other aspects will become apparent and more readily appreciated from the following description of the embodiments, taken in conjunction with the accompanying drawings in which:

FIG. 1A is a conceptual view illustrating a triple-phase boundary of an embodiment of a composite;

FIG. 1B is a conceptual view illustrating a triple-phase boundary of a composite of nickel oxide/yttria-stabilized zirconia (NiO/YSZ) composite;

FIG. 2 is a cross-sectional view schematically illustrating a structure of an embodiment of a solid oxide fuel cell;

FIG. 3A is a graph of energy change (dE, electron volts, eV) versus reaction coordinate showing an energy relationship in an anodic reaction on the (211) plane of an embodiment of a nickel compound;

FIG. 3B is a graph of energy change (dE, electron volts, eV) versus number of carbon atoms showing a stability of a carbon structure on the (322) plane of an embodiment of a nickel compound;

FIG. 4 is a graph of intensity (arbitrary units, a.u.) versus scattering angle (degrees two-theta, 20) showing results of X-ray diffraction (XRD) analysis of a screen-printed product before performing a heat treatment at a temperature of about 1,300° C. in Preparation Examples 1-2 and Comparative Preparation Example 1;

FIG. 5 is a graph of intensity (arbitrary units, a.u.) versus scattering angle (degrees two-theta, 20) showing results of X-ray diffraction (XRD) analysis of a screen-printed product after performing a heat treatment at a temperature of about 1,300° C. in Preparation Examples 1 and 2 and Comparative Preparation Example 1;

FIG. 6 is a graph of an imaginary component of resistance (Z″, ohms·cm²) versus a real component of resistance (Z′, ohms·cm²) showing impedance characteristics of a symmetric cell in a hydrogen atmosphere according to Example 1;

FIG. 7 is a graph of an imaginary component of resistance (Z″, ohms·cm²) versus a real component of resistance (Z′, ohms·cm²) showing impedance characteristics of a symmetric cell in a hydrogen atmosphere according to Comparative Example 1;

FIG. 8 is a graph of an imaginary component of resistance (Z″, ohms·cm²) versus a real component of resistance (Z′, ohms·cm²) showing impedance characteristics of a symmetric cell in a methane atmosphere according to Example 1;

FIG. 9 is a graph of an imaginary component of resistance (Z₂, ohms·cm²) versus a real component of resistance (Z₁, ohms·cm²) showing impedance characteristics of a symmetric cell in a methane atmosphere according to Comparative Example 1;

FIG. 10 is a graph of methane conversion rate (percent) versus temperature (° C.) showing a methane conversion rate of methane conversion reaction in symmetric cells prepared according to Example 1 and Comparative Example 1; and

FIG. 11 is a graph of specific resistivity (Rₚ (ohms·cm²) versus time (minutes, min) showing anode specific resistivity in symmetric cells prepared according to Example 1 and Comparative Example 1.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. “Or” means “and/or.” Expressions such as “at least one of,” when preceding a list of elements, or “or a combination thereof” when following a list, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

A composite according to an aspect may include a nickel compound represented by Formula 1 and yttria-stabilized zirconia (“YSZ”) cerium (Ce), titanium (Ti), or a combination thereof:

Ni₁₋ₓM1ₓO_{y} Formula 1

wherein, in Formula 1, M1 may comprise silicon (Si), germanium (Ge), molybdenum (Mo), or a combination thereof, and 0≦x≦0.3 and 0≦y≦3.

In Formula 1, x may be in a range from about 0 to about 0.1, and y may be in a range from about 0.5 to about 1.5.

The Ce and Ti included in the YSZ are maintained in the form of a solid solution while forming one phase with the nickel compound, which is represented by Formula 1 above, in the composite, and thus provide improved electronic conductivity.

The YSZ comprising Ce, Ti, or a combination thereof may be a compound that is represented by Formula 2:

ZrₐM2_{b}Y_{c}O_{2-d} Formula 2

wherein, in Formula 2, M2 may comprise Ce, Ti, or a combination thereof, and 0.75≦a≦0.85, 0≦b≦0.12, 0.13≦c≦0.15, and 0≦d≦2.

The YSZ may comprise, for example, a compound that is represented by Formula 3:

ZrₐCe_{b}Y_{c}O_{2-d} Formula 3

wherein, in Formula 3, 0.75≦a≦0.85, 0≦b≦0.12, 0.13≦c≦0.15, and 0≦d≦2.

In Formulas 2 and 3, d may be a value that makes the oxide electrically neutral. For example, d may be a value that represents an oxygen vacancy.

In Formulas 2 and 3, a may be in a range from about 0.80 to about 0.84, and b may be in a range from about 0.02 to about 0.06.

The composite may be available as a material for an electrode, and the electrode may be used in a fuel cell or an electrolyzer. The electrode may be suitable for use as an anode.

In some embodiments, the composite may be an anode material for a solid oxide fuel cell (“SOFC”).

An anode material according to an embodiment may comprise, and in an embodiment consist of, a mixed phase of the nickel compound and the YSZ, wherein the nickel compound may be an electronic conductor represented by Formula 1, and the YSZ may be an ionic conductor Ce, Ti, or a combination thereof. The electronic conductor and the ionic conductor may provide electrons and ions, respectively, for a reaction, and the anodic reaction may occur at a triple-phase boundary (“TPB”) where the mixed phase and a fuel meet together.

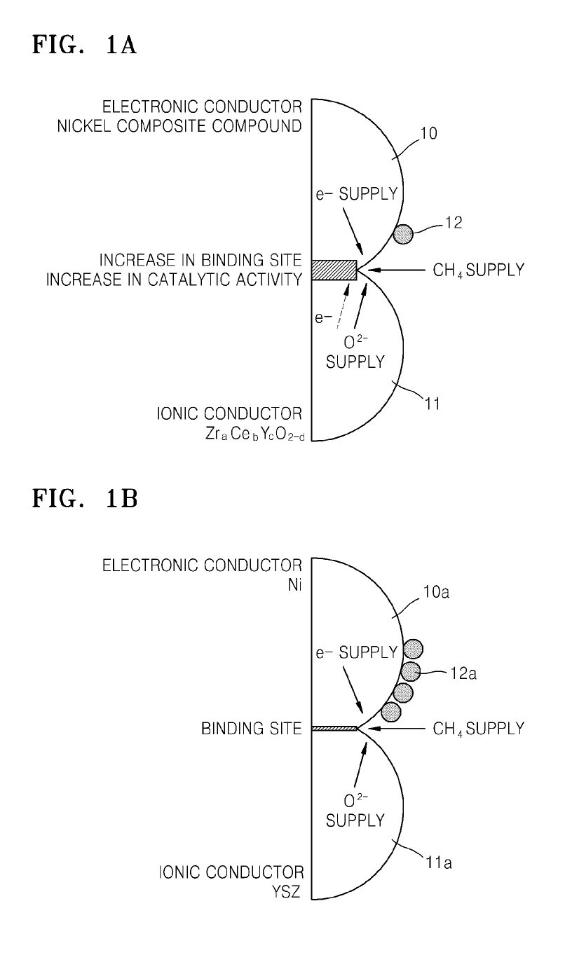

FIG. 1A is a conceptual view illustrating a TPB of an anode when the anode material is used for an SOFC using methane as a fuel. As illustrated in FIG. 1A, the compound of Formula 3 according to an embodiment is suitable for use as an ionic conductor, and the nickel compound of Formula 1 according to another embodiment is suitable for use as an electronic conductor.

FIG. 1B is a conceptual view illustrating a TPB of an anode when a composite of nickel oxide/yttria-stabilized zirconia (NiO/YSZ) is used as the anode material so as to compare with the composite of FIG. 1A.

Referring to FIGS. 1A and 1B, a nickel compound 10 and a nickel element 10a may both have a catalytic activity and serve as an electronic conductor. A compound 11 of Formula 3 and YSZ 11a may serve as an ionic conductor. The nickel compound 10 provides excellent resistance to carbon poisoning. Thus, when a hydrocarbon such as methane is used as a fuel, the nickel composite compound 10 may reduce an amount of elemental carbon 12 and 12a deposited on the electronic conductor, compared to the nickel element 10a. Therefore, the nickel compound 10 may provide increased catalytic activity for decomposing a hydrocarbon and reducing carbon poisoning thereafter.

The compound 11 of Formula 3 above may introduce Ce, Ti, or a combination thereof to the nickel compound 10, which is an electronic conductor, to supply electrons thereto. Then, the improved electronic conductivity may increase the catalytic activity and an area of the TPB at which the anodic reaction occur, the TPB where the ionic conductor (e.g., the compound of Formula 3), the electronic conductor (i.e., the nickel composite compound of Formula 1), and the fuel (e.g., methane) meet together. An area of a binding site in the TPB may be also increased so that the anodic reaction may go smoothly and excellent electronic and ionic conductivities may be provided, thereby, reducing polarization resistance of an electrode.

The nickel compound 10 may be an alloy or an oxide thereof that comprises a nickel element as a primary component. While becoming an oxidation catalyst for hydrogen or methane and serving as an electronic conductor, the nickel compound 10 may provide improved electronic conductivity and the catalytic activity to the Ce— containing YSZ.

The nickel compound 10 may be an alloy or an oxide thereof that includes a nickel element and Mo, Si, Ge, or a combination thereof. The nickel compound 10 may be in the form of a solid solution having a homogeneous phase in which Mo, Si, Ge, or a combination thereof are dissolved in a crystal of a nickel element and/or a nickel oxide. The nickel compound 10 may comprise, for example, Ni₁₋ₓMoₓO_{y}, Ni₁₋ₓMoₓ, Ni₁₋ₓSiₓO_{y}, Ni₁₋ₓSiₓ, Ni₁₋ₓGeₓO_{y}, or Ni₁₋ₓGeₓ (wherein, 0≦x≦0.3, and 0≦y≦3), or a combination thereof.

In greater detail, the nickel compound 10 may comprise Ni_{0.98}Mo_{0.02}O_{1.0}, or Ni_{0.98}Mo_{0.02}, or a combination thereof.

The nickel composite compound 10 may be synthesized by using an impregnation method, the method comprising impregnating a metal M1 into a nickel precursor such as NiO. The method may include, for example, contacting a nickel precursor such as nickel nitrate and a metal precursor such as metal (M1) nitrate together to form a mixture, wherein the nickel precursor and the metal precursor are provided according to a desired composition within a solvent, and performing a heat treatment to obtain a nickel compound that is represented by Formula 1:

Ni₁₋ₓM1ₓO_{y} Formula 1

wherein, in Formula 1, M1 may be Si, Ge, Mo, or a combination thereof, and 0≦x≦0.3 and 003.

The heat treatment may be performed in an inert gas or a reducing atmosphere.

When the heat treatment is performed in an inert gas atmosphere, the nickel compound of Formula 1 may be in the form of a nickel composite oxide, wherein y in Formula 1 is not 0.

When the heat treatment is performed in a reducing atmosphere, the nickel compound of Formula 1 above may be in the form of a nickel complex alloy, wherein y in Formula 1 is 0.

The inert gas atmosphere may comprise nitrogen or argon gas, and the reducing atmosphere may comprise, for example, hydrogen gas or methane gas.

In some embodiments, a heat treatment is performed in an inert gas atmosphere and a nickel compound of Formula 1 is obtained in the form of an oxide, wherein y in Formula 1 is not 0. When preparing an anode using the same, the nickel composite oxide may be naturally reduced in a H₂ or methane reducing atmosphere of the anode during SOFC operation process. Therefore, a nickel compound of Formula 1 in the form of an alloy, wherein y in Formula 1 is 0, may be formed.

The nickel compound in the form of an oxide (wherein, y in Formula 1 is not 0) has improved storage stability than that of the nickel compound in the form of an alloy (wherein, y in Formula 1 is 0) since the nickel composite oxide is a stable compound compared to the nickel composite alloy.

In the nickel compound of Formula 1 above, M1 may be Si, Mo, Ge, or a combination thereof.

The excellent resistance to carbon poisoning with regard to the nickel compound may be evaluated and confirmed by performing a calculation based a density functional theory (“DFT”).

The DFT calculation may be performed using the commercial software Vienna Ab-initio Simulation Package (“VASP”). The nickel compound may be provided by substituting one or more nickel elements, which are selected from the planes (111), (211), or (322) of a pure nickel elements, with Si, Sn, Ge, Mo, or Ce. For the purposes of DFT calculation, the nickel compound refers to a nickel alloy including nickel and Si, Sn, Ge, Mo, or Ce.

The stability of an anodic reaction and a carbon structure using a nickel compound as a catalyst are compared with stability of another anodic reaction and a carbon structure using a pure nickel element so as to evaluate the reactivity and resistance to carbon poisoning.

1) Stability Evaluation on Anodic Reaction with Regard to Nickel Compound.

Anodic reaction: CH₄(g)+H₂O(g)+O*→C*+6H*+O*→CO(g)+H₂(g)+H₂O(g) Reaction Formula 1

wherein, * may indicate a state of an element being adsorbed on a surface thereof.

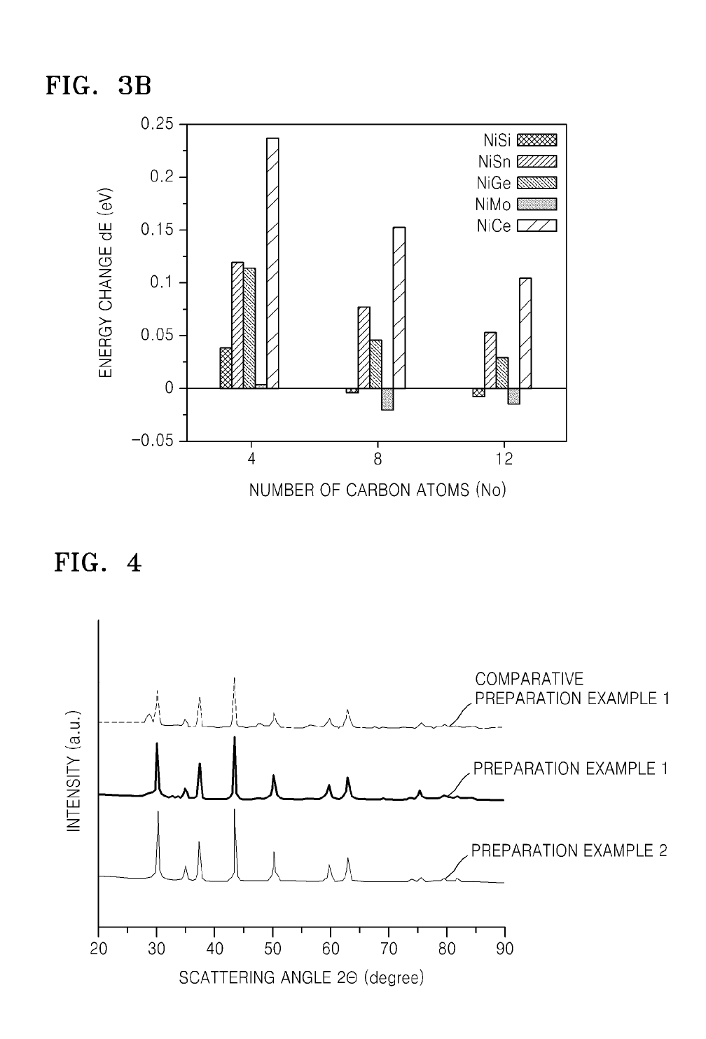

As is further described above, the energy relationship in an anodic reaction with regard to a nickel element and a nickel compound including Si, Sn, Ge, Mo, or Ce is as shown in FIG. 3A, and the calculation based on the DFT is performed on each (211) plane of the nickel compounds. Referring to FIG. 3A, the reactivity of the anodic reaction with regard to the nickel compound may be determined by the energy difference between the largest value and the smallest value in each step of the reaction. For example, the reactivity of the nickel compound including Si, Mo, or Ge is not significantly different from the reactivity of the pure nickel element. The larger energy difference the nickel compound has in the last step of the reaction in FIG. 3A, which is C*+6H*+O*→CO*+6H*, the stronger driving force the nickel compound may have in order to remove elemental carbon present on the surface. Based on the results shown in FIG. 3A, it was confirmed that the nickel compound may facilitate the removal of elemental carbon, thereby, the resistance to carbon poisoning may be also increased.

2) Stability Evaluation of a Carbon Structure on the Nickel Compound.

In order to determine the resistance to carbon poisoning for the nickel compound, stability of a carbon structure on the nickel compound was compared with the stability of a carbon structure on the pure nickel element. As the energy of a carbon structure gets higher, the carbon structure becomes less stable, and resistance to carbon poisoning is increased. For a calculation of the carbon structure energy on the surface of the nickel compound, the carbon structure is formed on the (322) plane of nickel, and then the energy is obtained by the DFT calculation. Based on the calculated energy, the stability of the carbon structure according to a type of elements included in the nickel compound is then shown in FIG. 3B.

In FIG. 3B, as the energy difference between the carbon structures each formed on the nickel compound and on the pure nickel element gets larger, the carbon structure formed on the nickel compound becomes unstable compared to the carbon structure formed on the pure nickel element. An x-axis in FIG. 3B indicates number of carbons used in the carbon structure. As the carbon structure gets bigger, it may be stabilized, but due to the elements included in the nickel compound in the beginning, the carbon structure may become less stable. That is, the nickel compound may inhibit nucleation when carbon poisoning occurs. Therefore, the resistance to carbon poisoning may be increased.

Based on the above-described DFT calculation, it may be confirmed that the nickel compound represented by Formula 1 may provide unexpected resistance to carbon poisoning when M1 therein is Si, Ge, or Mo.

A composite according to another embodiment may include Ce-containing YSZ in the form of a solid solution.

A crystal structure of the Ce-containing YSZ in the form of a solid solution may be a structure of a fluorite. For example, the Ce-containing YSZ in the form of a solid solution may have a structure similar to a structure of a fluorite.

Since the Ce-containing YSZ has both ionic and electronic conductivities at the same time as a mixed ionic and electronic conductor (“MIEC”), the Ce-containing YSZ may have excellent electrode activity, thereby, being granted for reducing polarization resistance of the anode. The Ce-containing YSZ may be, for example, Zr_{0.80}Ce_{0.06}Y_{0.14O2-d}, Zr_{0.84}Ce_{0.02}Y_{0.14O2-d}, Z_{r0.81}Ce_{0.05Y0.14O2-d}, Zr_{0.85}Ce_{0.05}Y_{0.15O2-d}, Zr_{0.67}Ce_{0.21}Y_{0.12O2-d}, Zr_{0.80}Ti_{0.06}Y_{0.14O2-d}, Zr_{0.84}Ti_{0.02}Y_{0.14O2-d}, Zr_{0.81}Ti_{0.05}Y_{0.14O2-d}, Zr_{0.85}Ti_{0.05Y0.15O2-d}, or Z_{r0.67}Ti_{0.21}Y_{0.12O2-d}, wherein 0≦d≦2. A combination comprising at least one of the foregoing may be used.

In greater detail, the Ce-containing YSZ may be Zr_{0.80}Ce_{0.06}Y_{0.14}O_{1.93}, Zr_{0.84}Ce_{0.02}Y_{0.14}O_{1.93}, or Zr_{0.81}Ce_{0.05}Y_{0.14}O_{1.93}. A combination comprising at least one of the foregoing may be used.

Examples of the composite may be Ni₁₋ₓMoₓO_{y-}Zr_{0.80}Ce_{0.06}Y_{0.14}O_{2-d}, Ni₁₋ₓMoₓO_{y-}Zr_{0.84}Ce_{0.02}Y_{0.14}O_{2-d}, Ni₁₋ₓMoₓO_{y-}Zr_{0.81}Ce_{0.05}Y_{0.14}O_{2-d}, Ni₁₋ₓMoₓO_{y-}Zr_{0.85}Ce_{0.05}Y_{0.15}O_{2-d}, Ni₁₋ₓMoₓO_{y-}Zr_{0.67}Ce_{0.21}Y_{0.12}O_{2-d}, Ni₁₋ₓMoₓO_{y-}Zr_{0.80}Ti_{0.06}Y_{0.14}O_{2-d}, Ni₁₋ₓMoₓO_{y-}Zr_{0.84}Ti_{0.02}Y_{0.14}O_{2-d}, Ni₁₋ₓMoₓO_{y-}Zr_{0.81}Ti_{0.05}Y_{0.14}O_{2-d}, Ni₁₋ₓMoₓO_{y-}Zr_{0.80}Ti_{0.05}Y_{0.15}O_{2-d}, Ni₁₋ₓMoₓO_{y}—Zr_{0.67}Ti_{0.21}Y_{0.12}O_{2-d}, Ni₁₋ₓMoₓ₋Zr_{0.80}Ce_{0.06}Y_{0.14}O_{2-d}, Ni₁₋ₓMoₓZr_{0.84}Ce_{0.02}Y_{0.14}O_{2-d}, Ni₁₋ₓMoₓ₋Zr_{0.81}Ce_{0.05}Y_{0.14}O_{2-d}, Ni₁₋ₓMoₓ₋Zr_{0.80}Ce_{0.05}Y_{0.15}O_{2-d}, Ni₁₋ₓMoₓ₋Zr_{0.67}Ce_{0.21}Y_{0.12}O_{2-d}, Ni₁₋ₓMoₓ₋Zr_{0.80}Ti_{0.06}Y_{0.14}O_{2-d}, Ni₁₋ₓMoₓZr_{0.84}Ti_{0.02}Y_{0.14}O_{2-d}, Ni₁₋ₓMoₓ₋Zr_{0.81}Ti_{0.05}Y_{0.14}O_{2-d}, Ni₁₋ₓMoₓ₋Zr_{0.80}Ti_{0.05}Y_{0.15}O_{2-d}, or Ni₁₋ₓMoₓ—Zr_{0.67}Ti_{0.21}Y_{0.12}O_{2-d}, wherein x is in a range of 0≦x≦0.3, y is in a range of 0≦y≦3, wherein A combination comprising at least one of the foregoing may be used.

In greater detail, the composite may be Ni_{0.98}Mo_{0.02}O_{1.0}—Zr_{0.80}Ce_{0.06}Y_{0.14}O_{1.93}, Ni_{0.98}Mo_{0.02}—Zr_{0.80}Ce_{0.06}Y_{0.14}O_{1.93}, Ni_{0.98}Mo_{0.02}O_{1.0}—Zr_{0.84}Ce_{0.02}Y_{0.14}O_{1.93}, Ni_{0.98}Mo_{0.02}—Zr_{0.84}Ce_{0.02}Y_{0.14}O_{1.93}, Ni_{0.98}Mo_{0.02}O_{1.0}—Zr_{0.81}Ce_{0.05}Y_{0.14}O_{1.93}, or Ni_{0.98}Mo_{0.02}—Zr_{0.81}Ce_{0.05}Y_{0.14}O_{1.93}. A combination comprising at least one of the foregoing may be used.

In order to increase the area of the TPB, the composite may comprise, or consist of, the nickel compound and the YSZ including Ce, Ti, or a combination thereof, each being in the form of nano-sized particles.

The nickel compound may have an average particle diameter of about 300 nanometers (nm) or less, for example, about 200 nm or less, or of about 100 nm or less, for example, in a range from about 10 nm to about 100 nm. A diameter of the YSZ including Ce, Ti, or a combination thereof may be larger than a diameter of the nickel-metal compound, for example, about 1 μm or less, particularly in a range from about 0.5 μm to about 1 μm. Likewise, when the YSZ including has a diameter that is larger than a diameter of the nickel-metal compound, a three-dimensional pore channel structure within the anode structure may be provided. Also, when the nickel compound has a diameter that is smaller than a diameter of the YSZ, the nickel compound may increase the area of the TPB in the anode so as to improve the performance thereof.

In the composite, an amount of the nickel compound and the YSZ including Ce, Ti, or a combination thereof may be determined by considering effects of the electrode resistance, output density, and the like.

The amount of the nickel compound in the composite according to another embodiment may be in a range from about 10 to about 90 parts by weight, for example, from about 30 to about 70 parts by weight, based on 100 parts by weight of the total weight of the composite. The amount of the YSZ including Ce, Ti or a combination thereof in the composite may be in a range from about 10 to 90 parts by weight, for example, from about 30 to about 70 parts by weight, based on 100 parts by weight of the total weight of the composite.

The composite may be synthesized by, for example, an impregnation method, and the nickel compound of Formula 1 (wherein, y in Formula 1 is 0) may be obtained by a further reduction during the synthesis. After directly applying the nickel composite oxide (wherein y in Formula 1 is not 0, that is, 0<y=3) to synthesize an anode, the nickel compound of Formula 1 (wherein y in Formula is 0) may be obtained by being naturally reduced in a H₂ or methane reducing atmosphere of the anode during SOFC operation process.

Through the reduction, the composite oxide may obtain, for example, a nickel metal compound that is represented by Formula 1:

Ni₁₋ₓM1ₓO_{y} Formula 1

wherein, in Formula 1, M may be Mo, Si, Ge, or a combination thereof, wherein 0<x≦0.3 and 0≦y≦3.

In Formula 1, x may indicate an amount of the Mo, Si, or Ge, or combination thereof that is dissolved in a crystal of a nickel element. Herein, in order to form a composition of Formula 1 wherein x is in a range of <x≦0.3, a molar ratio of the nickel oxide and the precursor of the Mo, Si, Ge, or a combination thereof may be selected.

In a composite according to another embodiment, a main peak of the YSZ including Ce, Ti, or a combination thereof is not observed at a Bragg (2θ) angle of 28.5°, 33.0°, 47.4°, and 56.3° two-theta (2θ) when CuKα X-rays having a wavelength of 1.541 Å are used as the radiation source. The peaks at a Bragg (2θ) angle of 28.5°, 33.0°, 47.4°, and 56.3° 2θ are peaks that correspond to crystalline CeO₂. Instead, the main peak of the YSZ including Ce, Ti, or a combination thereof is observed at a Bragg (2θ) angle in a range from about 30° to about 44° 28, for example, from about 30.1° to about 43.4° 2θ.

Hereinafter, a method of manufacturing a composite according to another embodiment will be described in further detail.

First, yttria-stabilized zirconia (“YSZ”) including cerium (Ce), titanium (Ti), or a combination thereof may be manufactured as follows:

A precursor including Ce, Ti, or a combination thereof is combined with a first solvent, and YSZ is added thereto to form a mixture. Then, the first solvent is removed from the mixture and a first heat treatment is performed to obtain YSZ including Ce, Ti, or a combination thereof.

Examples of the precursor including Ce, Ti, or a combination thereof are cerium nitrate, cerium sulfate, or titanium nitrate.

Examples of the first solvent are ethanol, water, or a combination thereof, and an amount of the first solvent may be in a range from about 100 to about 2,000 parts by weight, based on 100 parts by weight of the precursor including Ce, Ti, or a combination thereof.

With regard to the amount of the precursor and the YSZ, a molar ratio thereof may be selected to form the YSZ, which has, for example, a composition of Formula 2 above.

The first heat treatment may be performed in an oxygen or air atmosphere at a temperature of about 300° C. to about 700° C. When the temperature and atmosphere of the first heat treatment is performed within the ranges above, a reaction yield of the YSZ including Ce, Ti, or a combination thereof may be excellent.

As a separate process from the above-described process, a precursor of the metal M1 is dissolved in a second solvent, and then a nickel precursor is mixed thereto. Examples of the nickel precursor are a nickel oxide, nickel nitrate, and the like.

The second solvent may be the same as the first solvent. An amount of the second solvent may be in a range from about 100 to about 2,000 parts by weight, based on 100 parts by weight of the precursor of the metal M1.

The precursor of the metal M1, which is a metal precursor of Mo, Si, Ge, or a combination thereof, may use ammonium hexamolybdate, silicon acetate, germanium chloride, or a combination thereof.

With regard to the amount of the nickel precursor and the metal M1 precursor, a molar ratio thereof may be selected to have a composition of Formula 1 above.

Then, a second heat treatment is performed on the resulting product having a composition of Formula 1 to obtain a nickel compound that is represented by Formula 1 below.

The second heat treatment may be performed in an oxygen or air atmosphere at a temperature of about 300° C. to about 700° C. When the temperature and atmosphere of the second heat treatment is performed within the ranges above, a reaction yield of the nickel compound represented by Formula 1 may be improved.

Next, the nickel compound represented by Formula 1 below is combined with the YSZ including Ce, Ti, or a combination thereof, and then a third heat treatment may be performed to obtain a composite including the nickel compound represented by Formula 1 and the YSZ including Ce, Ti, or a combination thereof:

Ni₁₋ₓM1ₓO_{y} Formula 1

wherein, in Formula 1, M may be Mo, Si, Ge, or a combination thereof, and 0<x≦0.3 and 0≦y≦3.

The third heat treatment may be performed in an inert gas or a reducing atmosphere at a temperature of about 800° C. to about 1,500° C. to obtain the nickel compound. Herein, the nickel compound may be in the form of an oxide.

The inert gas atmosphere may use inert gas such as nitrogen and argon.

A drying process may be further provided prior to the third heat treatment.

The drying process may be performed at a temperature of about 50° C. to about 150° C.

After directly applying the composite including the nickel compound and the YSZ to prepare an anode, the nickel compound in the form of an oxide may be naturally reduced in a H₂ or methane reducing atmosphere of the anode during SOFC operation process. Thus, the composite including the nickel compound in the form of an oxide and the YSZ is converted to the composite including the nickel compound (where y in Formula 1 is 0) and the YSZ. The nickel compound (where y in Formula 1 is 0) is a reduction product of the nickel compound in the form of an oxide.

The nickel compound (wherein y in Formula 1 is 0<y≦3) in the form of an oxide in the composite may be thermodynamically more stable at room temperature than the nickel compound (wherein y in Formula 1 is 0), which is a reduction product of the nickel compound in the form of an oxide.

In another embodiment, when the third heat treatment is performed in a reducing atmosphere, a composite including the nickel compound (wherein y in Formula 1 is 0<y≦3) and the YSZ including Ce, Ti, or a combination thereof may be obtained. According to another aspect, a fuel cell includes the electrode.

The fuel cell may be a SOFC including the electrode.

The SOFC may include the composite as an anode material for the SOFC; a cathode disposed opposite to the anode; and a solid oxide electrolyte interposed between the anode and the cathode.

The SOFC may have a stack structure of membrane and electrode assembly (“MEA”). For example, a plurality of the MEAs each comprising, e.g., consisting of, a cathode, an anode, and a solid oxide electrolyte may be stacked in series, and a separator that electrically connects the plurality of the MEAs may be interposed between each of the MEAs to form a stack structure.

A general electrochemical reaction of an SOFC may include a cathodic reaction where oxygen gas O₂ of the cathode is reduced to oxygen ions O²⁻, and an anodic reaction where oxygen ions transferred through a fuel of the anode (i.e., hydrocarbon such as H₂ and methane) and electrolyte are reacted.

When having an electrolyte between an anode and a cathode, and constantly providing a fuel and air to the anode and the cathode, respectively, to maintain a difference of oxygen partial pressure therebetween, a driving force required for transferring oxygen through the electrolyte may be formed. When such reactions continue to occur, electrons may flow to an external conducting wire through the electrodes.

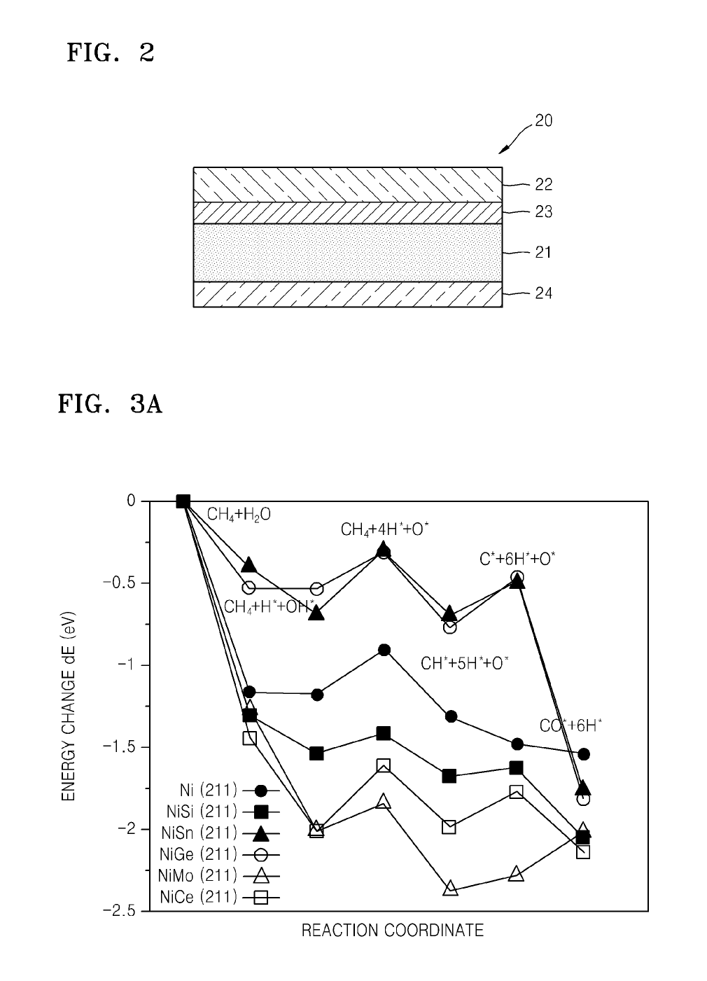

FIG. 2 is a cross-sectional view schematically illustrating a structure of an embodiment of a SOFC. Referring to FIG. 2, in a SOFC 20, a cathode 22 and an anode 24 may be disposed on opposite sides of a solid oxide electrolyte 21.

The anode 24 may include a composite according to an embodiment.

The solid oxide electrolyte 21 is desirably dense enough to prevent mixing of air and a fuel together, and have a high conductivity with regard to oxygen ions and a low electronic conductivity. In addition, the solid oxide electrolyte 21 has the cathode 22 and the anode 24, which have a large difference in oxygen partial pressure, on both sides of the solid oxide electrolyte 21. Therefore, it desirably maintains the physical properties described above in a wide region of the oxygen partial pressure.

Materials composing the solid oxide electrolyte 21 are not limited if the materials are generally available in the art, and for example, may include a zirconia-based solid electrolyte, a ceria-based solid electrolyte, a bismuth oxide-based solid electrolyte, or lanthanum gallate-based solid electrolyte, or a combination thereof. For example, the solid oxide electrolyte 21 may include zirconia undoped or doped with yttrium, scandium, calcium, magnesium, or a combination thereof; ceria undoped or doped with gadolinium, samarium, lanthanum, ytterbium, neodymium, or a combination thereof; bismuth oxide undoped or doped with calcium, strontium, barium, gadolinium, yttrium, or a combination thereof; or lanthanum gallate undoped or doped with strontium, magnesium, or a combination thereof. Examples of the solid oxide electrolyte 21 are yttria-stabilized zirconia (“YSZ”), scandium-stabilized zirconia (“ScSZ”), samaria doped ceria (“SDC”), gadolinia doped ceria (“GDC”), and the like.

A thickness of the solid oxide electrolyte 21 may be in a range from about 10 nm to about 100 μm. For example, the thickness of the solid oxide electrolyte 21 may be in a range from about 100 nm to about 50 μm.

The cathode 22 (e.g., the air electrode) may reduce oxygen gas to oxygen ions, and maintain oxygen partial pressure by constantly flowing air to the cathode. A material for the cathode 22 may be, for example, a metal oxide particle having a Perovskite-type crystal structure. Examples of the material for the cathode are (La,Sr)MnO₃, (La,Ca)MnO₃, (Sm,Sr)CoO₃, (La,Sr)CoO₃, (La,Sr)(Fe,Co)O₃, (La,Sr)(Fe,Co,Ni)O₃, and (Ba,Sr)(Co,Fe)O₃. In some embodiments, the cathode 22 may be, for example, a metal oxide that is doped with a transition metal element or an lanthanum-based element on (Ba,Sr)(Co,Fe)O₃(BSCF) having a Perovskite-type crystal structure, and the metal oxide may improve its stability by improving thermal expansion properties of the BSCF. For example, the improved BSCF-based cathode material may be a compound represented by Formula 4 below:

Ba_{a′}Sr_{b′}Co_{x′}Fe_{y′}M′_{1-x′-y′}O_{3-η} Formula 4

wherein, in Formula 4, M′ may be a transition metal element, or an lanthanum-based element, or a combination thereof,

a′ and b′ may be in a range of 0.4≦a′≦0.6 and 0.4≦b′≦0.6, respectively,

x′ and y′ may be in a range of 0.6≦x′≦0.9 and 0.1≦y′≦0.4, respectively, and

η may be a value that makes the compound of Formula 4 electrically neutral.

Herein, M′ may be Mn, Zn, Ni, Ti, Nb, Cu, Ho, Yb, Er, Tm, or a combination thereof.

As the cathode material, a noble metal such as platinum, ruthenium, or palladium may be used. The above-described cathode materials may be used alone or as a combination of two or more materials. Also, a single layer or multiple layer structures with different cathode materials may be formed.

A thickness of the cathode 22 may be in a range from about 1 to about 100 μm. For example, the thickness of a first cathode 120 may be in a range from about 5 to about 50 μm.

In order to more efficiently prevent a reaction between the cathode 22 and the solid oxide electrolyte 21, a functional layer 23 may be interposed therebetween if desired. The functional layer 23 may include, for example, GDC, SDC, YDC, or a combination thereof. A thickness of the functional layer 23 may be in a range from about 1 to about 50 μm, for example, in a range from about 2 to about 10 μm.

The anode 24 may serve for an electrochemical fuel oxidation and a charge transfer. The anode 24 may include the above-described composite as the anode material for the SOFC. Further detailed description about the composite will be omitted since it is already described above.

A thickness of the anode 24 may be in a range from about 1 to about 1,000 μm. For example, the thickness of the anode 24 may be in a range from about 5 to about 100 μm.

The SOFC may be manufactured using any suitable method, the details of which may be determined by one of skill in the art without undue experimentation. Also, the SOFC may be in the form of various structures such as a tubular stack, a flat tubular stack, and a planar-type stack.

Hereinafter, one or more embodiments will be described in further detail with reference to the following examples. However, these examples shall not limit the scope of the disclosed embodiments.

### EXAMPLES

### Preparation Example 1

### Preparation of Composite

1.86 g of cerium nitrate was dissolved in 20 ml of ethanol to prepare an ethanol solution of cerium nitrate. 4 g of YSZ (Y_{0.15}Zr_{0.85}O_{1.925}) was impregnated with the ethanol solution of cerium nitrate to prepare a reaction mixture. After removing ethanol from the reaction mixture, the resultant was thermal treated in an air atmosphere at a temperature of about 500° C. for about 4 hours to obtain Zr_{0.80}Ce_{0.06}Y_{0.14}O_{1.93}.

2 g of ammonium hexamolybdate was dissolved in 20 mL of ethanol to prepare an ethanol solution of ammonium hexamolybdate. 6 g of Ni_{1.0}O_{1.0} was impregnated with the ethanol solution of ammonium hexamolybdate to prepare a reaction mixture. Then, after removing ethanol from the reaction mixture, the resultant was thermal treated in air atmosphere at a temperature of about 500° C. for about 4 hours to obtain Ni_{0.98}Mo_{0.02}O_{1.0}.

After mixing 4 g of Zr_{0.80}Ce_{0.06}Y_{0.14}O_{1.93} and 6 g of Ni_{0.98}Mo_{0.02}O_{1.0} together and then ball-milled, the mixture was dried at a temperature of about 100° C. Then, the dried powder was heat treated in an inert gas (i.e., nitrogen gas) atmosphere at a temperature of about 1,300° C. to obtain a composite of Ni_{0.98}Mo_{0.02}O_{1.0}—Zr_{0.80}Ce_{0.06}Y_{0.14}O_{1.93}.

An amount of Zr_{0.80}Ce_{0.06}Y_{0.14}O_{1.93} included in the composite was about 40 parts by weight based on 100 parts by weight of a total amount of the composite, and an amount of Ni_{0.98}Mo_{0.02}O_{1.0} included in the composite was about 60 parts by weight based on 100 parts by weight of a total amount of the total composite.

### Preparation Example 2

### Preparation of Composite

A composite of Ni_{0.98}Mo_{0.02}O_{1.0}—Zr_{0.84}Ce_{0.02}Y_{0.14}O_{1.93} was obtained in the same manner as in Preparation Example 1, except that 0.465 g of cerium nitrate, instead of 1.86 g of cerium nitrate, was used.

### Preparation Example 3

### Preparation of Composite

A composite of Ni_{0.98}Mo_{0.02}O1.0-Zr_{0.81}Ce_{0.05}Y_{0.14}O_{1.93} was prepared in the same manner as in Preparation Example 1, except that 1.4 g of cerium nitrate, instead of 1.86 g of cerium nitrate, was used.

### Preparation Example 4

### Preparation of Composite

After mixing 2 g of ammonium hexamolybdate and 6 g of Ni_{1.0}O_{1.0} together and then ball-milled, the mixture was dried at a temperature of about 100° C. Then, 1.6 g of the dried product was mixed with 2.4 g of Y_{0.15}Zr_{0.85}O_{1.925}, then ball-milled and dried. Next, the dried powder was impregnated with 0.47 g of cerium nitrate. After drying the mixture, the dried powder was heat treated in a nitrogen gas atmosphere at a temperature of about 1,300° C. to obtain a composite of Ni_{0.98}Mo_{0.02}O_{1.0}—Zr_{0.81}Ce_{0.05}Y_{0.14}O_{1.93}.

### Comparative Preparation Example 1

### Preparation of Composite

3.6 g of NiO and 2.4 g of Y_{0.15}Zr_{0.85}O_{1.925} were mixed together, and then ball-milled to be dried at a temperature of 100° C. Next, the dried product was heat treated in a nitrogen gas atmosphere at a temperature of about 1,300° C. to prepare a composite of Ni_{0.0}O_{1.0}—Zr_{0.85}Y_{0.15}O_{1.925}.

### Examples 1-4

### Preparation of Symmetric Cell

A symmetric cell that is coated by a pair of anodes was obtained on both sides of an electrolyte layer.

With regard to preparation of a symmetrical cell, an electrolyte layer was formed using YSZ (i.e., Zr_{0.80}Y_{0.14}O_{2-d}, wherein d is a value that makes a YSZ metal oxide represented by the formula above electrically neutral, and is in a range of 0≦d≦2) powder (available from FCM, USA). The powder was pressed using a metal mold, then the pressed pellet was calcined at a temperature of about 1,550° C. for about 8 hours to prepare a bulk molding, which has a thickness of 1 mm formed in a of coin shape, as an electrolyte layer.

In order to form an anode on both sides of an electrolyte layer, In order to form anodes on both sides of the electrolyte layer, the composites prepared according to Preparation Examples 1-4 were each mixed with ink vehicle (available from FCM, USA) to prepare a slurry. The slurry was screen-printed on both sides of the electrolyte layer, and then a heat treatment was performed at a temperature of 1,300° C. for about 2 hours. Afterward, preparation of the symmetrical cell was complete by forming anodes having a thickness of about 20 μm.

### Comparative Example 1

### Preparation of Comparative Symmetric Cell

A comparative symmetric cell was obtained in the same manner as in Example 1, except that a composite of Ni_{1.0}O_{1.0}—Zr_{0.85}Y_{0.15}O_{1.925} prepared according to Comparative Preparation Example, instead of a composite prepared according to Preparation Example 1, was used.

### Evaluation Example 1

### Analysis of X-Ray Diffraction (XRD)

XRD patterns with regard to materials were measured before and after performing a heat treatment at a temperature of 1,300° C. in Preparation Examples 1-2 and Comparative Preparation Example 1.

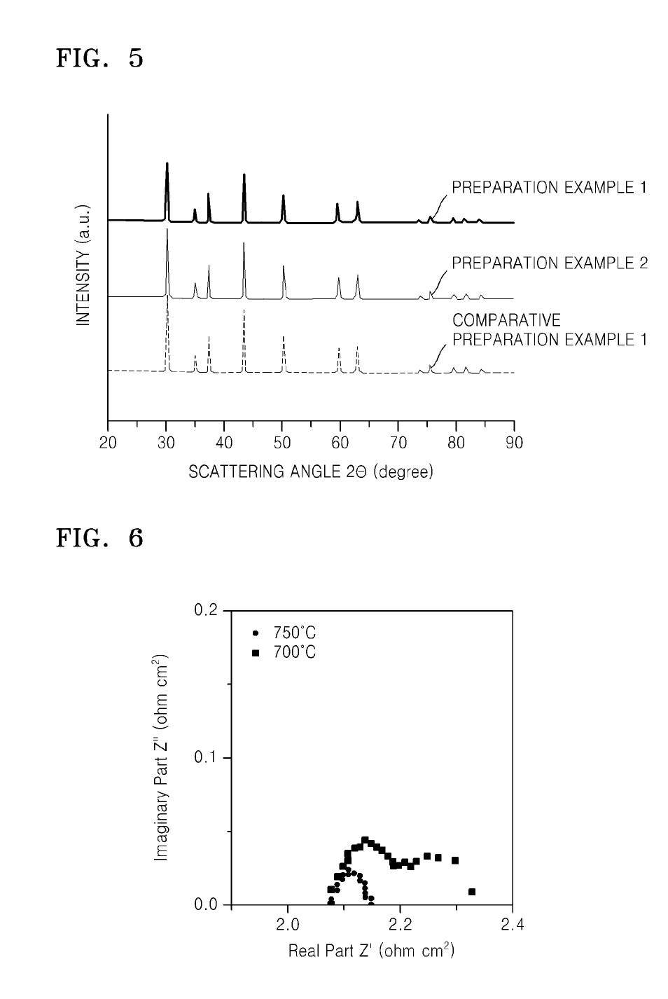

Results of the XRD analysis (i.e., MP-XRD, Xpert PRO, and Philips/Power 3 kW) with regard to Preparation Examples 1-2, and Comparative Preparation Example 1 were shown in FIGS. 4 and 5, respectively.

FIG. 4 is a graph showing the results of XRD analysis of a screen-printed product before performing a heat treatment at a temperature of 1,300° C. on the composites prepared according to Preparation Examples 1-2 and the materials prepared according to Comparative Preparation Example 1. FIG. 5 is a graph showing the results of XRD analysis of a screen-printed product after performing a heat treatment at a temperature of about 1,300° C.

Referring to FIG. 4, with regard to powder undoped with Ce, a general XRD pattern of Ni-YSZ was obtained. Peaks observed at angles in 37.4°, 43.4°, 62.9°, 75.5°, and 79.4° 2θ were originated from NiO, and peaks observed at angles in 30.1°, 35.0°, 50.2°, 59.7°, 62.6°, 73.7°, 81.6°, and 84.1° 2θ were originated from YSZ. No particular peak was observed with regard to the composite prepared according to Preparation Example 2 that has a small amount of Ce. However, a CeO₂ peak was observed at an angle in about 28.5° with regard to the composite prepared according to Preparation Example 1.

Referring to FIG. 5, the XRD pattern of the composite prepared according to Example 2 was not significantly different from the XRD pattern of the composite, which was not doped with Ce according to Comparative Example 1. A CeO₂ peak that was observed before performing a heat treatment was not observed anymore after performing a heat treatment at a temperature of about 1,300° C. With regard to the composite prepared according to Example 1, peaks corresponding to the YSZ moved to a low angle, thereby, it was confirmed that ZrₐCe_{b}Y_{c}O_{2-d} phase may be formed without CeO₂ phase.

### Evaluation Example 2

### Impedance Measurement

1) Impedance in Hydrogen Atmosphere

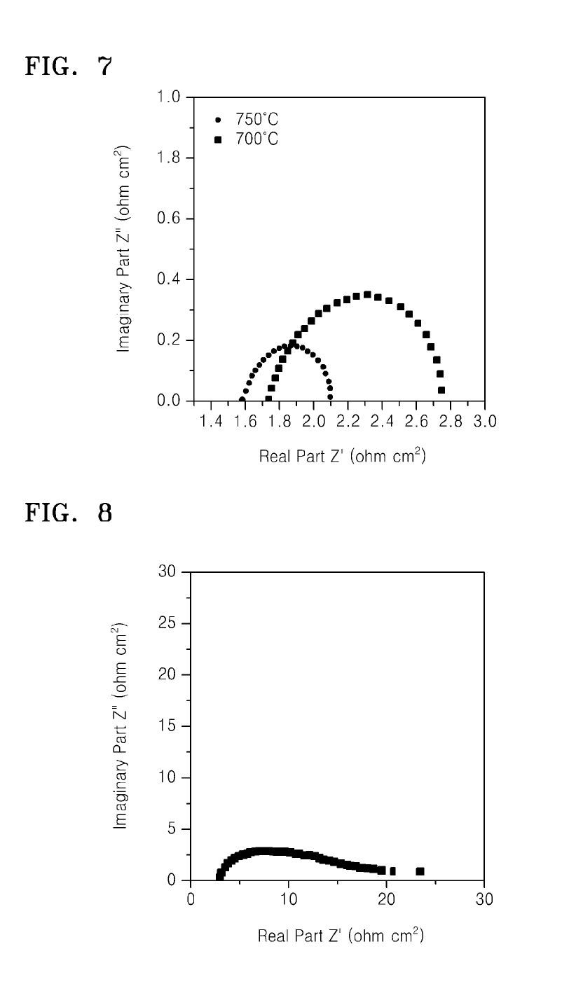

Impedance of each of the symmetric cells was measured in a hydrogen H₂ atmosphere by varying the operating temperatures of the symmetric cells prepared according to Example 1 and Comparative Example 1. An impedance measuring apparatus was Materials mates 7260 available from Materials Mates Company. Also, when the operating temperatures of the MEAs were maintained in a range from 700° C. to 750° C., impedance results thereof were shown in FIGS. 6 and 7, respectively.

FIGS. 6 and 7 were graphs each showing impedance characteristics of the symmetric cells prepared according to Example 1 and Comparative Example 1 in the H₂ atmosphere.

In the symmetric cells prepared according to Example 1, the anode included a composite of Ni_{0.98}Mo_{0.02}—Zr_{0.80}Ce_{0.06}Y_{0.14}O_{1.93} that was generated by a reduction of a composite of Ni_{0.98}Mo_{0.02}O_{1.0}—Zr_{0.80}Ce_{0.06}Y_{0.14}O_{1.93} by hydrogen.

In the symmetric cells prepared according to Comparative Example 1, the anode included a composite of Ni—Zr_{0.85}Y_{0.15}O_{1.925} that was generated by a reduction of a composite of Ni_{1.0}O_{1.0}—Zr_{0.85}Y_{0.15}O_{1.925} by hydrogen. In FIGS. 6 and 7, a size of semicircles (i.e., a diameter of the semicircle) is related to a magnitude of anode resistance (Rₐ). As shown in FIGS. 6 and 7, the symmetric cell prepared according to Example 1 has small semicircles compared to the symmetric cell prepared according to Comparative Example 1, and thus it was confirmed that electrode resistance was reduced in the symmetric cell prepared according to Example 1.

2) Impedance in Methane Atmosphere

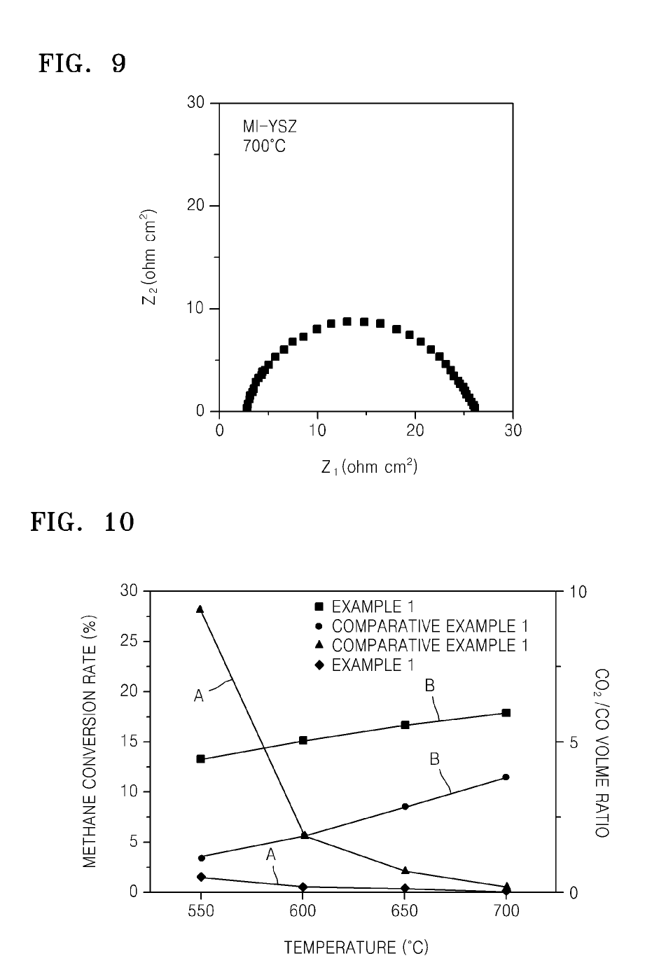

Impedance of each of the symmetric cells was measured in a methane CH₄ atmosphere by varying the operating temperatures of the symmetric cells prepared according to Example 1 and Comparative Example 1. An impedance measuring apparatus was Materials mates 7260 available from Materials Mates Company. Also, when the operating temperatures of the MEAs were maintained at a temperature of about 700° C., impedance results thereof were shown in FIGS. 8 and 9, respectively. FIGS. 8 and 9 were graphs each showing impedance characteristics of the symmetric cells prepared according to Example 1 and Comparative Example 1 in the CH₄ atmosphere.

In the symmetrical cells prepared according to Example 1, the anode included a composite of Ni_{0.98}Mo_{0.02}—Zr_{0.80}Ce_{0.06}Y_{0.14}O_{1.93} that was generated by a reduction of Ni_{0.98}Mo_{0.02}O_{1.0}—Zr_{0.80}Ce_{0.06}Y_{0.14}O_{1.93} by hydrogen.

In the symmetrical cells prepared according to Comparative Example 1, the anode included a composite of Ni—Zr_{0.85}Y_{0.15}O_{1.925} that was generated by a reduction of Ni_{1.0}O_{1.0}—Zr_{0.85}Y_{0.15}O_{1.925} by hydrogen.

Referring to FIGS. 7 and 8, the symmetric cell prepared according to Example 1 has low resistance values compared to the symmetric cells prepared according to Comparative Example 1. Likewise, the symmetric cell prepared according to Example 1 shows low electrode resistance characteristics in the CH₄ atmosphere compare to the same symmetric cell in the H₂ atmosphere.

### Evaluation Example 3

### Methane Conversion Experiment

0.2 g of each of the composite prepared according to Preparation Example 1 and the composite of Ni_{1.0}O_{1.0}—Zr_{0.85}Y_{0.15}O_{1.925} prepared according to Comparative Example 1 were mixed with 2 g of quartz beads, and then put in a quartz tube reactor. The quartz tube reactor was then heated from room temperature to a temperature of about 700° C. for about 1 hour in atmosphere of hydrogen at 100 cc/min and nitrogen at 200 cc/min. By injecting methane at 40 cc/min, oxygen at 5 cc/min, and nitrogen at 400 cc/min at each temperature, a methane conversion rate and a volume ratio of CO₂/CO were measured. Herein, the methane conversion rate was obtained by dividing an amount of the methane reaction by an amount of methane that was injected into the reactor.

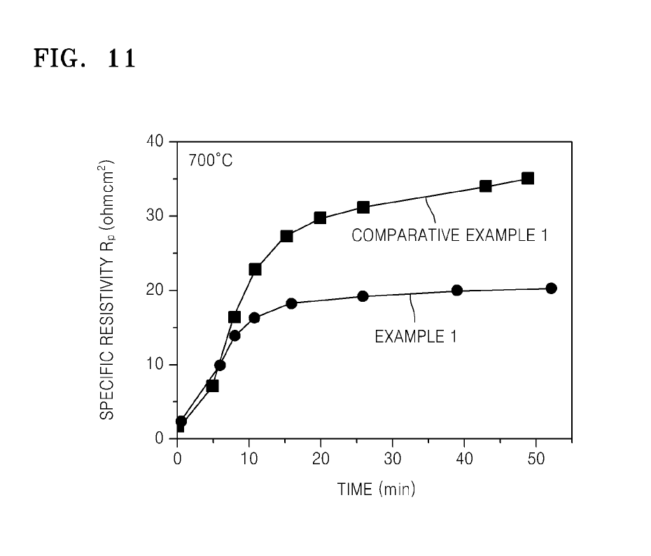

As a result of the methane conversion reaction, the methane conversion rate was measured and shown in FIG. 10. In FIG. 10, a graph indicated as A represents the methane conversion rate, and a graph indicated as B represent the volume ratio of CO₂/CO.

Referring to FIG. 10, the symmetric cell prepared according to Example 1 was found to be increased in a whole temperature region compared to the symmetric cell prepared according to Comparative Example 1. Therefore, it was confirmed that use of the symmetric cell prepared according to Example 1 may lower the resistance of the electrodes by catalyzing a surface chemical reaction.

### Evaluation Example 4

### Anode Specific Resistivity Measurement

Impedance of each of the symmetric cells was measured in the CH₄ atmosphere by varying operating temperatures of the symmetric cells prepared according to Example 1 and Comparative Example 1. The impedance measuring apparatus was Materials mates 7260 available from Materials Mates Company. An anode specific resistivity (wherein, Rₚ═Rₜ/2 for being a symmetric cell (1/2)), which was calculated based on total resistance (Rₜ) of the symmetrical cells according to the operating temperatures, is represented as a function of the temperature, and the results are shown in FIG. 11.

In the symmetric cell prepared according to Example 1, the anode included a composite of Ni_{0.98}Mo_{0.02}—Z_{r0.80}Ce_{0.06}Y_{0.14}O_{1.93} that was generated by a reduction of composite of Ni_{0.98}Mo_{0.02}O_{1.0}—Zr_{0.80}Ce_{0.06}Y_{0.14}O_{1.93} by hydrogen.

In the symmetric cell prepared according to Comparative Example 1, the anode included a composite of Ni—Zr_{0.85}Y_{0.15}O_{1.925} that was generated by a reduction of a composite of Ni_{1.0}O_{1.0}—Zr_{0.85}Y_{0.15}O_{1.925} by hydrogen.

Referring to FIG. 11, Referring to FIG. 11, the symmetric cell prepared according to Example 1 has low resistance values compared to the symmetrical cells prepared according to Comparative Example 1 so that it was confirmed that the symmetric cell prepared according to Example 1 may increase resistance to carbon deposition.

As described above, according to one or more of the above embodiments, a composite may not only improve resistance to carbon deposition and have excellent oxidation activity for fuels, but also show low electrode resistance. Therefore, an electrode for a high-efficiency fuel cell may be prepared using the same.

It should be understood that the exemplary embodiments described therein should be considered in a descriptive sense only and not for purposes of limitation. Descriptions of features, advantages, or aspects within each embodiment should be considered as available for other similar features, advantages or aspects in other embodiments.

What is claimed is:

1. A composite comprising:
a nickel compound represented by Formula 1:
Ni₁₋ₓM1ₓO_{y} Formula 1
wherein M1 is silicon (Si), germanium (Ge), molybdenum (Mo), or a combination thereof, and 0≦x≦0.3 and 0≦y≦3; and
a yttria-stabilized zirconia comprising cerium (Ce), titanium (Ti), or a combination thereof.

2. The composite of claim 1, wherein the yttria-stabilized zirconia is represented by Formula 2:
ZrₐM2_{b}Y_{c}O_{2-d} Formula 2
wherein M2 is Ce, Ti, or a combination thereof, and 0.75≦a≦0.85, 0<b≦0.12, 0.13≦c≦0.15, and 0≦d≦2.

3. The composite of claim 1, wherein the yttria-stabilized zirconia is represented by Formula 3:
ZrₐCe_{b}Y_{c}O_{2-d}
wherein 0.75≦a≦0.85, 0≦b≦0.12, 0.13≦c≦0.15, and 0≦d≦2.

4. The composite of claim 1, wherein in Formula 1, x is in a range from about 0 to about 0.1, and y is in a range from about 0.5 to about 1.5.

5. The composite of claim 3, wherein in Formula 3, a is in a range from about 0.80 to about 0.84, and b is in a range from about 0.02 to about 0.06.

6. The composite of claim 1, wherein the nickel compound represented by Formula 1 comprises Ni₁₋ₓMoₓO_{y}, Ni₁₋ₓMoₓ, Ni₁₋ₓSiₓO_{y}, Ni₁₋ₓSiₓ, Ni₁₋ₓGeₓO_{y}, or Ni₁₋ₓGeₓ, wherein 0≦x≦0.3 and 0≦y≦3, and
the yttria-stabilized zirconia comprises Zr_{0.80}Ce_{0.06}Y_{0.14}O_{2-d}, Zr_{0.84}Ce_{0.02}Y_{0.14}O_{2-d}, Zr_{0.81}Ce_{0.05}Y_{0.14}O_{2-d}, Zr_{0.85}Ce_{0.05}Y_{0.15}O_{2-d}, Zr_{0.67}Ce_{0.21}Y_{0.12}O_{2-d}, Zr_{0.80}Ti_{0.06}Y_{0.14}O_{2-d}, Zr_{0.84}Ti_{0.02}Y_{0.14}O_{2-d}, Zr_{0.81}Ti_{0.05}Y_{0.14}O_{2-d}, Zr_{0.85}Ti_{0.05}Y_{0.15}O_{2-d}, or Zr_{0.67}Ti_{0.21}Y_{0.12}O_{2-d}, wherein 0≦d≦2.

7. The composite of claim 6, wherein the nickel compound represented by Formula 1 is Ni_{0.98}Mo_{0.02}O_{1.0} or Ni_{0.98}Mo_{0.02}, and
the yttria-stabilized zirconia is Zr_{0.80}Ce_{0.06}Y_{0.14}O_{1.93}, Zr_{0.80}Ce_{0.06}Y_{0.14}O_{1.93}, Zr_{0.84}Ce_{0.02}Y_{0.14}O_{1.93}, Zr_{0.84}Ce_{0.02}Y_{0.14}O_{1.93}, Zr_{0.81}Ce_{0.05}Y_{0.14}O_{1.93}, or Zr_{0.81}Ce_{0.05}Y_{0.14}O_{1.93}.

8. The composite of claim 1, wherein the composite is Ni₁₋ₓMoₓO_{y}—Zr_{0.80}Ce_{0.06}Y_{0.14}O_{2-d}, Ni₁₋ₓMoₓO_{y}—Zr_{0.84}Ce_{0.02}Y_{0.14}O_{2-d}, Ni₁₋ₓMoₓO_{y}—Zr_{0.81}Ce_{0.05}Y_{0.14}O_{2-d}, Ni₁₋ₓMoₓO_{y}—Zr_{0.85}Ce_{0.05}Y_{0.15}O_{2-d}, Ni₁₋ₓMoₓO_{y}—Zr_{0.67}Ce_{0.21}Y_{0.12}O_{2-d}, Ni₁₋ₓMoₓO_{y}—Zr_{0.80}Ti_{0.06}Y_{0.14}O_{2-d}, Ni₁₋ₓMoₓO_{y}—Zr_{0.84}Ti_{0.02}Y_{0.14}O_{2-d}, Ni₁₋ₓMoₓO_{y}—Zr_{0.81}Ti_{0.05}Y_{0.14}O_{2-d}, Ni₁₋ₓMoₓO_{y}—Zr_{0.80}Ti_{0.05}Y_{0.15}O_{2-d}, Ni₁₋ₓMoₓO_{y}—Zr_{0.67}Ti_{0.21}Y_{0.12}O_{2-d}, Ni₁₋ₓMoₓ—Zr_{0.80}Ce_{0.06}Y_{0.14}O_{2-d}, Ni₁₋ₓMoₓ—Zr_{0.84}Ce_{0.02}Y_{0.14}O_{2-d}, Ni₁₋ₓMoₓ—Z_{r0.81}Ce_{0.05}Y_{0.14}O_{2-d}, Ni₁₋ₓMoₓ—Zr_{0.80}Ce_{0.05}Y_{0.15}O_{2-d}, Ni₁₋ₓMoₓ—Zr_{0.67}Ce_{0.21}Y_{0.12}O_{2-d}, Ni₁₋ₓMoₓ—Zr_{0.80}Ti_{0.06}Y_{0.14}O_{2-d}, Ni₁₋ₓMoₓ—Zr_{0.84}Ti_{0.02}Y_{0.14}O_{2-d}, Ni₁₋ₓMoₓ—Zr_{0.81}Ti_{0.05}Y_{0.14}O₂-d, Ni₁₋ₓMoₓ—Zr_{0.80}Ti_{0.05}Y_{0.15}O_{2-d}, or Ni₁₋ₓMoₓ—Zr_{0.67}Ti_{0.21}Y_{0.12}O_{2-d}, wherein 0≦x≦0.3, 0≦y≦3, and 0≦d≦2.

9. The composite of claim 1, wherein the composite is Ni_{0.98}Mo_{0.02}O_{1.0}—Zr_{0.80}Ce_{0.06}Y_{0.14}O_{1.933}, Ni_{0.98}Mo_{0.02}—Zr_{0.80}Ce_{0.06}Y_{0.14}O_{1.93}, Ni_{0.98}Mo_{0.02}O_{1.0}—Zr_{0.84}Ce_{0.02}Y_{0.14}O_{1.93}, Ni_{0.98}Mo_{0.02}—Zr_{0.84}Ce_{0.02}Y_{0.14}O_{1.93}, Ni_{0.98}Mo_{0.02}O_{1.0}—Zr_{0.81}Ce_{0.05}Y_{0.14}O_{1.93}, or Ni_{0.98}Mo_{0.02}—Zr_{0.81}Ce_{0.05}Y_{0.14}O_{1.93}.

10. The composite of claim 1, wherein an amount of the nickel compound represented by Formula 1 is in a range from about 1 to about 99 parts by weight, based on 100 parts by weight of a total weight of the composite, and
an amount of the yttria-stabilized zirconia is in a range from about 99 to about 1 part by weight, based on 100 parts by weight of a total weight of the composite.

11. The composite of claim 1, wherein a main peak of the yttria-stabilized zirconia is observed at a Bragg angle in a range from about 30° two-theta to about 44° two-theta when using CuKα X-rays having a wavelength of 1.541 angstroms.

12. An electrode comprising a composite, the composite comprising:
a nickel compound represented by Formula 1:
Ni₁₋ₓM1ₓO_{y} Formula 1
wherein M1 is silicon (Si), germanium (Ge), molybdenum (Mo), or a combination thereof, and 0≦x≦0.3 and 0≦y≦3; and
a yttria-stabilized zirconia comprising cerium (Ce), titanium (Ti), or a combination thereof.

13. The electrode of claim 12, wherein the yttria-stabilized zirconia is represented by Formula 2 below:
ZrₐM2_{b}Y_{c}O_{2-d} Formula 2
wherein M2 is Ce, Ti, or a combination thereof, and 0.75≦a≦0.85, 0<b≦0.12, 0.13≦c≦0.15, and 0≦d≦2.

14. The electrode of claim 12, wherein the yttria-stabilized zirconia is represented by Formula 3:
ZrₐCe_{b}Y_{c}O_{2-d} Formula 3
wherein 0.75≦a≦0.85, 0≦b≦0.12, 0.13≦c≦0.15, and 0≦d≦2.

15. The electrode of claim 12, wherein the nickel compound represented by Formula 1 comprises Ni₁₋ₓMoₓO_{y}, Ni₁₋ₓMoₓ, Ni₁₋ₓSiₓO_{y}, Ni₁₋ₓSiₓ, Ni₁₋ₓGeₓO_{y}, or Ni₁₋ₓGeₓ, wherein 0≦x≦0.3 and 0≦y≦3, and
the yttria-stabilized zirconia comprises Zr_{0.80}Ce_{0.06}Y_{0.14}O_{2-d}, Zr_{0.84}Ce_{0.02}Y_{0.14}O_{2-d}, Zr_{0.81}Ce_{0.05}Y_{0.14}O_{2-d}, Zr_{0.85}Ce_{0.05}Y_{0.15}O_{2-d}, Zr_{0.67}Ce_{0.21}Y_{0.12}O_{2-d}, Zr_{0.80}Ti_{0.06}Y_{0.14}O_{2-d}, Zr_{0.84}Ti_{0.02}Y_{0.14}O_{2-d}, Zr_{0.81}Ti_{0.05}Y_{0.14}O_{2-d}, Zr_{0.85}Ti_{0.05}Y_{0.15}O_{2-d}, or Zr_{0.67}Ti_{0.21}Y_{0.12}O_{2-d}, wherein 0≦d≦2.

16. The electrode of claim 12, wherein the composite is Ni₁₋ₓMoₓO_{y-}Zr_{0.80}Ce_{0.06}Y_{0.14}O_{2-d}, Ni₁₋ₓMoₓO_{y}—Zr_{0.84}Ce_{0.02}Y_{0.14}O_{2-d}, Ni₁₋ₓMoₓO_{y}—Zr_{0.81}Ce_{0.05}Y_{0.14}O_{2-d}, Ni₁₋ₓMoₓO_{y}—Zr_{0.85}Ce_{0.05}Y_{0.15}O_{2-d}, Ni₁₋ₓMoₓO_{y}—Zr_{0.67}Ce_{0.21}Y_{0.12}O_{2-d}, Ni₁₋ₓMoₓO_{y}—Zr_{0.80}Ti_{0.06}Y_{0.14}O_{2-d}, Ni₁₋ₓMoₓO_{y}—Zr_{0.84}Ti_{0.02}Y_{0.14}O_{2-d}, Ni₁₋ₓMoₓO_{y}—Zr_{0.81}Ti_{0.05}Y_{0.14}O_{2-d}, Ni₁₋ₓMoₓO_{y}—Zr_{0.80}Ti_{0.05}Y_{0.15}O_{2-d}, Ni₁₋ₓMoₓO_{y}—Zr_{0.67}Ti_{0.21}Y_{0.12}O_{2-d}, Ni₁₋ₓMoₓ—Zr_{0.80}Ce_{0.06}Y_{0.14}O_{2-d}, Ni₁₋ₓMoₓ—Zr_{0.84}Ce_{0.02}Y_{0.14}O_{2-d}, Ni₁₋ₓMoₓ—Zr_{0.81}Ce_{0.05}Y_{0.14}O_{2-d}, Ni₁₋ₓMoₓ—Zr_{0.80}Ce_{0.05}Y_{0.15}O_{2-d}, Ni₁₋ₓMoₓ—Zr_{0.67}Ce_{0.21}Y_{0.12}O_{2-d}, Ni₁₋ₓMoₓ—Zr_{0.80}Ti_{0.06}Y_{0.14}O_{2-d}, Ni₁₋ₓMoₓ—Zr_{0.84}Ti_{0.02}Y_{0.14}O_{2-d}, Ni₁₋ₓMoₓ—Zr_{0.81}Ti_{0.05}Y_{0.14}O_{2-d}, Ni₁₋ₓMoₓ—Zr_{0.80}Ti_{0.05}Y_{0.15}O_{2-d}, or Ni₁₋ₓMoₓ—Zr_{0.67}Ti_{0.21}Y_{0.12}O_{2-d},
wherein 0≦x≦0.3, 0≦y≦3, and 0≦d≦2.

17. The electrode of claim 12, wherein the composite is Ni_{0.98}Mo_{0.02}O_{1.0}—Zr_{0.80}Ce_{0.06}Y_{0.14}O_{1.933}, Ni_{0.98}Mo_{0.02}—Zr_{0.80}Ce_{0.06}Y_{0.14}O_{1.93}, Ni_{0.98}Mo_{0.02}O_{1.0}—Zr_{0.84}Ce_{0.02}Y_{0.14}O_{1.933}, Ni_{0.98}Mo_{0.02}—Zr_{0.84}Ce_{0.02}Y_{0.14}O_{1.93}, Ni_{0.98}Mo_{0.02}O_{1.0}—Zr_{0.81}Ce_{0.05}Y_{0.14}O_{1.93}, or Ni_{0.98}Mo_{0.02}—Zr_{0.81}Ce_{0.05}Y_{0.14}O_{1.93}.

18. The electrode of claim 12, wherein an amount of the nickel compound represented by Formula 1 is in a range from about 1 to about 99 parts by weight, based on 100 parts by weight of a total weight of the composite, and
an amount of the yttria-stabilized zirconia is in a range from about 99 to about 1 part by weight, based on 100 parts by weight of a total weight of the composite.

19. A fuel cell comprising the electrode of claim 12.

20. The fuel cell of claim 19, wherein the fuel cell is a solid oxide fuel cell comprising:
a cathode;
an anode; and
a solid oxide electrolyte interposed between the cathode and the anode.
